(19) United States
(12) Patent Application Publication
(10) Pub. No.: US 2022/0386683 A1
(43) Pub. Date: Dec. 8, 2022

(54) Crumbed Tobacco Substrate

(71) Applicant: JT International SA, Geneva (CH)

(72) Inventor: Sandra Spieles, Trier (DE)

(73) Assignee: JT International SA, Geneva (CH)

(21) Appl. No.: 17/776,487

(22) PCT Filed: Nov. 11, 2020
(86) PCT No.: PCT/EP2020/081753

§ 371 Date: May 12, 2022

(30) Foreign Application Priority Data
Nov. 15, 2019 (EP) 19209350.8

(51) Int. Cl. A24B 15/167; A24B 15/14; A24B 15/40; A24B 15/28

(52) U.S. Cl. CPC A24B 15/167; A24B 15/14; A24B 15/403; A24B 15/285

(57) ABSTRACT

An aerosol releasing substrate for use in a heat-not-burn device is air permeable and includes tobacco particles and/or an inhalable agent, which contains at least one of a stimulant and/or a flavor, a gelling agent for gelling the aerosol releasing substrate, a degradation preventing and/or thickening stabilizer, and 30-70% humectant. The aerosol releasing substrate further has a soft granular texture. A method of producing a soft granular aerosol releasing substrate for use in a heat-not-burn device, which is air permeable, includes the steps: a) forming a mixture by mixing tobacco particles and/or an inhalable agent, which contains at least one of a stimulant and/or a flavor, a gelling agent for gelling the aerosol releasing substrate, a degradation preventing and/or thickening stabilizer, and 30-70% humectant, and b) forming a soft granular structure from the mixture.

### CROSS-REFERENCE TO RELATED APPLICATIONS

The present application is a national phase entry under 35 U.S.C. § 371 of International Application No. PCT/EP2020/081753, filed Nov. 11, 2020, published in English, which claims priority to European Application No. 19209350.8 filed Nov. 15, 2019, the disclo-sures of which are incorporated herein by reference.

### FIELD OF THE INVENTION

The present invention relates to a granular aerosol releasing substrate containing, tobacco particles, a gelling agent, a degradation preventing stabilizer and herein 10-80% humectant. Furthermore, the present invention relates to a method to produce a granular aerosol releasing substrate.

### BACKGROUND OF THE INVENTION

Electronic cigarettes (e-cigarettes) are popular and widespread. They came with the need and possibility for novel tobacco products to be vaporized and inhaled by smokers. Usually those E-cigarettes or similar devices like electronic pipes generate an aerosol by heating a liquid containing flavors, an aerosol forming agent, such as water and optionally nicotine.

However, this can lead to an uneven smoking profile, wherein the experienced flavor of puffs can differ significantly, e.g. by an inefficient extraction of key compounds in the liquid. Therefore, consumers search for alternative to tobacco products to be heated but not burned.

Meanwhile Heat-not-burn devices, with which tobacco can be heated instead of burned became popular. Those Heat-not-burn devices provide tobacco based vapor and can be filled with a couple tobacco products that will be heated up to around 350° C. by activating an electronic heater. Tobacco products suitable for use in a Heat-not-Burn device need a high surface area and at least a certain amount of an aerosol forming agent. Such tobacco products are e.g. foamed tobacco, tobacco sticks, or simply reconstituted tobacco. Tobacco sticks comprise shredded tobacco leaves that are pressed into sticks, contain a low amount of humectant and are surrounded by a plastic capsule. Due to the closed bubbles within the foamed tobacco, it has a low surface area and therefore a low airflow through the substrate.

Due to their brittleness and shape, both foamed tobacco and tobacco sticks are difficult to handle and especially difficult to dose and therefore difficult to be filled in pods of Heat-not-Burn devices. Moreover, due to the low aeration of the foamed tobacco and the low amount of humectant in tobacco sticks and reconstituted tobacco, the vape generation of these tobacco products is also low.

### BRIEF SUMMARY OF THE INVENTION

It is therefore the objective of the invention to provide an aerosol releasing tobacco substrate, that is easy to dose, to handle, especially easy to be filled in pods of Heat-not-Burn devices and moreover, that has the capability to produce more vape than conventional tobacco products.

The afore-mentioned problems are eliminated by an aerosol releasing substrate for use in a heat-not-burn device, which is air permeable and comprises tobacco particles and/or an inhalable agent, which contains at least one of a stimulant and/or a flavor, a gelling agent for gelling the aerosol releasing substrate, a degradation preventing and/or thickening stabilizer and 30-70% humectant. The aerosol releasing substrate also has a soft granular texture.

As the humectant produces aerosol when it is heated, the aerosol releasing substrate has a soft structure and is capable of releasing a high amount of aerosol when it comprises humectant extending an amount of 30% of the composition of the substrate. The substrate is therefore able to produce much more aerosol/vape than conventional tobacco products. Beneficial to the high amount of humectant is the granulated texture, as particles generally have a high external surface that additionally extend the release of aerosol/vape. Furthermore, due to the granular texture the substrate is easily doseable and fillable into pods of Heat-not-Burn devices or other receptacles, such as receptacles for transportation and distribution of the substrate.

It is further conceivable that the aerosol releasing substrate has particle sizes greater than 0.3 mm, preferably greater than 0.5 mm and preferably greater than 1.0 mm and/or particle sizes smaller than 10 mm, preferably smaller than 5 mm, preferably smaller than 3 mm. The particle sizes of the aerosol releasing substrate are most preferred in the range of between 0.3 mm and 4 mm and especially preferred above 0.4 mm. These particle sizes are optimal for dosing the substrate. Further, such sizes allow the pods of Heat-not-Burn devices to be filled with a sufficient number of substrate particles. Small particles with said sizes are especially useful in terms of releasing aerosol. Such small particles have higher external surfaces than larger sized particles and are therefore able to release much more aerosol than larger sized particles. On the other hand, extremely small particles below 0.1 mm may not contain enough tobacco particles and/or particles of inhalable agent to release sufficient flavor to enrich the aerosol.

According to a preferred embodiment the weight of the tobacco and/or inhalable agent is greater than 5 wt.-%, preferably greater than 10 wt.-% and preferably greater than 20 wt.-% of the weight of the aerosol releasing substrate and/or the weight of the tobacco and/or inhalable agent is smaller than 70 wt.-%, preferably smaller than 60 wt.-%, preferably smaller than 40 wt.-% of the weight of the aerosol releasing substrate. Most preferred is an amount of tobacco of between 30% and 40% of the weight of the substrate.

This ensures a sufficient amount of tobacco flavor and stimulant in the substrate. If the amount of tobacco is increased above e.g. 50 wt. % of the weight of the substrate, the amount of other constituents, e.g. humectant or stabilizer must be reduced, so that the substrate may become too brittle and unstable or the release of vape is too low.

In a preferred embodiment, the tobacco and/or inhalable agent contains at least one sort of tobacco, an extract of tobacco and/or at least one non-tobacco flavoring agent, whereby the sort of tobacco has a particle size (Dv90) greater than 100 μm, preferably greater than 200 μm, preferably greater than 400 μm, preferably equal to or greater than 500 μm and/or a particle size smaller than 1000 μm, preferably smaller than 900 μm, preferably smaller than 800 μm, preferably smaller than 700 μm, preferably equal to or lower than 600 μm.

Preferred is a lognormal particle distribution of the tobacco and/or inhalable agent particles within the substrate. It is also possible that the tobacco particles have different sizes or the particles contain at least two or more fractions. For example a first fraction with sizes of between 50 μm and 100 μm mixed with a second fraction with sizes of between 400 μm and 600 μm, or a first fraction with particles having a size of less than 50 μm and a second fraction with particles having a size of more than 50 μm.

Preferred may be a mixture of a first fraction with particle sizes extending 600 μm and a second fraction with particle sizes below 400 μm. With specific particles sizes of the tobacco, extract of tobacco and/or inhalable agent the harshness of the substrate particles is adjustable. Particles smaller than 50 μm preferably smaller than 100 μm are difficult to process, wherein particles with sizes above 1000 μm are not useful, because the number of tobacco particles within the substrate particles may be too little to release sufficient flavor and/or stimulant to produce the aerosol.

In a preferred embodiment the tobacco, extract of tobacco and/or inhalable agent can preferably be any compound, mixture, particle matter and/or solution that may be inhaled, for example as a gas and/or aerosol, and it e.g. includes and/or carries at least one of a stimulant, e.g. caffeine, guarana and combinations thereof. The tobacco may further contain essentially at least one sort of tobacco, preferred a blend of at least two or more different sorts of tobacco. With a blend of different sorts of tobacco the taste is adjustable and can be adjusted to a preferred taste of the consumer.

In another embodiment the inhalable agent and/or the flavor may contain menthol, natural and/or artificial plant flavors, saccharides, animal flavors, other flavorings known for use in conventional e-liquids e.g. cinnamon, sage, herb, chamomile, kudzu (Pueraria lobata), Hydrangeae dulcis folium, clove, lavender, cardamom, caryophyllus, nutmeg, bergamot, geranium, honey essence, rose oil, lemon, orange, cassia bark, caraway, jasmine, ginger, coriander, vanilla extract, spearmint, peppermint, cassia, coffee, celery, cascarilla, sandalwood, cocoa, ylang ylang, fennel, anise, licorice, St John's bread, prune extract, and peach extract; saccharides, e.g., glucose, fructose, isomerized saccharide, and caramel; cocoa, e.g., pow-der and extract; esters, e.g., isoamyl acetate, linalyl acetate, isoamyl propionate, and linalyl butyrate; ketones, e.g., menthone, ionone, damascenone, and ethyl maltol; alcohols, e.g., geraniol, linalool, anethole, and eugenol; aldehydes, e.g., vanillin, benzaldehyde, and anisaldehyde; lactones, e.g., γ-undecalactone and γ-nonalactone; animal flavors, e.g., musk, ambergris, civet, and castoreum; and hydrocarbons, e.g., limonene and pinene, and combinations thereof, without being limited thereto. Such a flavor or others can be used alone or in combination. It is also possible that the inhalable agent and/or flavor and/or a combination of flavors may be combined with at least one or more sorts of tobacco, so that the taste of the substrate is adjustable to an optimum of a preferred taste of the consumer.

In a preferred embodiment, the humectant comprises glycerol, propylene glycol, ethanol and/or water. It is also possible, that the humectant comprises other alcohols and/or glycol derivatives, sebacate esters, and/or mixtures thereof, without being limited thereto. A glycol derivative that can be used in certain embodiments is propylene glycol, and a suitable sebacate ester can be di-2-ethylhexyl sebacate. Furthermore, any possible combinations of compounds belonging to the above-mentioned classes can be used. For example, a combination of glycerol and propylene glycol can be used as aerosol forming agent. Most of these humectants are tasteless and thus do not cover the original taste of tobacco, extracts of tobacco and/or inhalable agents, such as flavors. However, a tasteless humectant is still capable of generating aerosol and vape that carries the taste of the tobacco, extracts of tobacco and/or inhalable agents, such as flavors. Furthermore, the humectant contributes to the consistence and formability of the substrate.

In a further preferred embodiment, the amount of the mixture of propylene glycol and glycerol is more than 10% preferably 20%, preferably 30% and/or less than 70%, preferably 60%, preferably 50% by weight of the substrate. The ratio of propylene glycol and glycerol is preferably between 80:20 and 20:80, preferably between 30:70 and 70:30, preferably between 40:60 and 60:40 and ideally, about 35:65. The glycerol and propylene glycol can be used with equal weight percent, but also with different weight percent, preferably with more than 10%, preferred 30%, preferred 40% by weight of glycerol and less than 90%, preferred 80%, preferred 70% by weight of glycerol mixed with propylene glycol with more than 10%, preferred 30%, preferred 40% by weight, and less than 90%, preferred 80%, preferred 70% by weight. Highly preferred is an excess of glycerol in relation to propylene glycol.

It is possible that the amount of propylene glycol is between 10% and 20% by weight of the substrate, wherein the amount of glycerol is between 20% and 30% by weight of the substrate. Ideally, a maximum amount of propylene glycol is 40% by weight of the substrate to obtain the granular texture. Thus, the two components can be suitably set regarding their ratio. The ratio of propylene glycol and glycerol influences the basic viscosity of the substrate, with a higher amount of glycerol leading to a higher viscosity and therefore to a better texture and formability of the substrate.

In a preferred embodiment the amount of humectant including e.g. water, glycerol and/or propylene glycol is more than 10% preferably more than 20%, preferably more than 30% by weight of the substrate and less than 90%, preferably less than 80%, preferably less than 70% by weight of the substrate. Preferably, the humectant comprises water in an amount greater than 1%, preferably greater than 2%, preferably greater than 3% and/or smaller than 20%, preferably smaller than 10%, preferably smaller than 6% and ideally between 2% and 5% by weight of the aerosol releasing substrate. Such an amount of humectant ensures the processability of the substrate during production and releases sufficient vape during consumption.

In a preferred embodiment the stabilizer comprises carboxymethylcellulose and/or hydroxyalkylated carbohydrates. Preferably used is a purified carboxymethylcellulose, such as Ceroga 4550 C or CEKOL® 2000 (C.E. Roeper GmbH). Stabilizers, such as carboxymethylcellulose acts as a binder to make the substrate crumbly and also help to prevents its degradation and thickens it.

Another preferred embodiment comprises a gelling agent, which is a non-protein containing polysaccharide and/or comprise gellan gum, lecithin, agar and/or mixtures thereof. The gelling agent, especially gellan gum, and preferably Gellan gum Roeper 700f, jellifies the substrate so that it is formable and moreover sievable. The gelling agent keeps the substrate soft and fluffy. Without the gelling agent, the substrate would become too hard and could become too brittle.

In a preferred embodiment, the bulk density of the aerosol releasing substrate is greater than 100 kg/m³, preferably greater than 200 kg/m³, preferably greater than 250 kg/m³ and/or lower than 500 kg/m³, preferably lower than 400 kg/m³, preferably lower than 350 kg/m³. Ideally, the density is between 300 and 250 kg/m³. A low density helps to ensure a good thermal conductivity and thus a desired level of aerosol generation of the substrate. Further, a low density of between 200 kg/m³ and 350 kg/m³ improves the fluidic flow through the substrate.

In a preferred embodiment, the aerosol releasing substrate is suitable to be filled in pods. When the substrate is suitable to be filled in pods, it is able to be used in electronic cigarettes and similar hot-not-burn devices.

The objective is also reached by a method of producing a soft granular aerosol releasing substrate for use in a heat-not-burn device, which is air permeable and comprises the steps:

a) Forming a mixture by mixing tobacco particles and/or an inhalable agent, which contains at least one of a stimulant and/or a flavor, a gelling agent for gelling the aerosol releasing substrate, a degradation preventing and/or thickening stabilizer and 30-70% humectant, and
b) Forming a soft granular structure from the mixture.

Preferably the granular aerosol releasing substrate produced in steps a) and b) has a composition and/or properties consistent with one or more embodiments described above and below, and may especially consistent with embodiments related to claims 1 to 10. Preferably liquid components and/or the humectant are mixed first, followed by at least one component of the gelling agent, preferably more or all gelling components to create a mixture. Ideally, the mixture is mechanically or otherwise, such as by an injection of air, aerated during mixing the mixture. Such sequence ensures a good adjustment of a soft consistence of the substrate and is beneficial for the production. However, it is possible that different components of the gelling agent are mixed before the liquid components and/or the liquid components may be mixed with the gelling agent in the same step.

More solid components, such as stabilizers, the tobacco and/or the inhalable agent may then be added to the mixture consisting of liquid and gelling components. That way the consistence of the mixture is best adjustable and processable. However, the sequence of adding the components to the mixture may be varied so that the sequence fits best into the production line. After mixing of the components of the substrate is finished, in step b. the mixture is formed to a granular structure. To form that granular structure the mixture is preferably sieved down to a granular texture, or an extruder is fed with the mixture. Another step may include grinding or milling the mixture or sieved particles of the mixture to reduce particle sizes to much smaller sizes. Small particle sizes advantageously enable a high release of aerosol and are easily dose- and processable.

In a preferred embodiment, an intermediate step between step a) and b) comprises feeding the substrate in an extruder and step b) comprises extruding the substrate through a die with at least one hole and cutting. Ideally, the die has multiple holes. Preferably, the ingredients of the mixture are placed in separate barrels and then fed to the extruder. After extruding the substrate, it is cut by cutting elements, such as knifes or rotating knifes. The number of holes in the die preferably depends on the desired sizes of the granules of the substrate and on the size of the die. Ideally, the sizes of the holes depend on the desired sizes of the granules of the substrate and thus is greater than 50 μm, preferably greater than 100 μm, preferably greater than 200 μm and/or smaller than 1000 μm, preferably smaller than 900 μm, preferably smaller than 800 μm. In consideration of an industrial scale production, the extrusion of the substrate is advantageous to reduce costs and make the production more effective.

Preferably the mixture is mixed at ambient or cold conditions and especially at ambient temperature. Thereby ambient temperature is considered to be room temperature. Preferably, the temperature is above 5° C., preferably above 10° C., preferably above 15° C. and below 100° C., preferably below 80° C., preferably below 60° C. The temperature may be optimal between 18° C. and 40° C., preferably between 20° C. and 30° C. However, it is possible that the components of the mixture are mixed at temperatures above 100° C., preferably above 80°, preferably above 50° C. Mixing at ambient conditions avoids the binder to activate before a use of the aerosol releasing substrate.

In a preferred embodiment, between step a) and step b), the mixture is aged. Ideally, the aging takes place at ambient or cold conditions. With an aging step, the mixture will be become more solid and clumping of mixture is reduced. Thus, the mixture can be sieved without clumping.

In a preferred embodiment, the mixture is aged for between 1 and 10 hours, preferably between 2 and 8 hours and/or at temperatures below 60° C. Preferably, the mixture is aged within a closed container or box to ensure that aging conditions are constant and will not be disturbed, e.g. due to fluctuations of the temperature, pressure and/or humidity. The duration of aging may be optimal above 1, preferably 2, preferably 4 hours and below 40, preferably 20, preferably 10 hours. The optimal duration may be between 1 and 24 hours, preferably between 2 and 6 hours, preferably between 3 and 5 hours. The mixture will have best properties after aging it within a few hours.

In a preferred embodiment, steps a), b) and in particular also intermediate steps take place at temperatures below 60° C., ideally, at ambient temperature. Ambient temperature is considered to be room temperature. The temperature is above 5° C., preferably above 10° C., preferably above 15° C. and below 100° C., preferably below 80° C., preferably below 60° C. The temperature may be optimal between 18° C. and 40° C., preferably between 20° C. and 30° C. However, it is possible that the components of the mixture are mixed at temperatures above 100° C., preferably above 80°, preferably above 50° C. Those temperatures will keep the important properties of the mixture and provide the best aging conditions so that sufficient humectant remains within the mixture without heating up the mixture.

In a preferred embodiment, during step b, the mixture is sieved down to particle sizes greater than 0.1 mm, preferably greater than 0.5 mm, preferably greater than 1 mm and/or up to particle sizes smaller than 10 mm, preferably smaller than 5 mm, preferably smaller than 3 mm. Particles smaller than 0.1 mm are difficult to process. Therefore, larger particles are preferred. The larger the particles the better to process them. However, extremely large particles cannot be handled and/or filled in pods of heat-not-burn articles.

### DETAILED DESCRIPTION

### Examples

The present invention will now be described in detail with reference to examples thereof. However, these examples are illustrative and do not limit the scope of the invention.

Table 1a: Components used in the present sample 1.

TABLE 1a
Components used in the present sample 1.

| | Sample 1 |
|---|---|
| Ingredients: | (wt. %) |
| Propylene glycol | 16 |
| Glycerol | 24 |
| Water or purified water | 3.8 |
| Gelling agent (gellan gum) | 6.8 |
| Tobacco particles | 33 |
| Stabilizer (cellulose derivative) | 16.5 |

### Example 1a

Table 1 shows components used in an exemplary embodiment of the soft granulated aerosol releasing substrate. The soft aerosol releasing substrate contains between 40% and 50% humectant by weight of the aerosol releasing substrate. The humectant comprises between 2% and 6% water as well as between 10% and 20% propylene glycol and between 20% and 30% glycerol by weight of the substrate. This amount of humectant results in a soft consistence of the substrate.

The granulated aerosol releasing substrate further contains a gelling agent, in particular in the form of gellan gum, in an amount an amount between 4% and 8% by weight of the aerosol releasing substrate. The gelling agent also participates to soften the substrate. A degradation preventing and/or thickening stabilizer or binder, especially based on cellulose and in particular based on a cellulose derivate, such as carboxylmethylcellulose is present in an amount between 14% and 20% by weight of the aerosol releasing substrate.

In the aerosol releasing substrate, tobacco is present in the form of particles, wherein the content of tobacco particles is between 30% and 40% by weight of the aerosol releasing substrate. The sizes of the tobacco particles are preferably between 0.4 mm and 0.8 mm. Larger sized particles might not fit into a final granular size of the aerosol releasing substrate granules, which are between 0.4 mm and 3 mm in size, wherein most of the granules (90 vol. %) are in the range of between 0.8 mm and 2.5 mm. The granular size of the aerosol releasing substrate and the tobacco particle size are measured by a Malvern 3000 laser diffraction particle size analyzer (v3.62) under dry dispersions.

The aerosol releasing substrate further has a bulk density of 300 kg/m³. The bulk density is determined by measuring the volume for three samples having a weight of 31.0+/−0.3 grams poured in steel cylinder bucket. An average value taken from the density results is calculated.

### Example 1 b

TABLE 1b
Components used in the present sample.

| | Sample 1 |
|---|---|
| Ingredients: | (wt. %) |
| Propylene glycol | 12.5 |
| Glycerol | 19.3 |
| Water or purified water | 2.8 |
| Gelling agent (gellan gum) | 4.7 |
| Tobacco particles | 49.0 |
| Stabilizer (cellulose derivative) | 11.7 |

The tobacco particles comprise nicotine as the stimulant. Due to the higher amount of tobacco particles, the nicotine release is higher in comparison to example 1 together with a higher sensorial impact than example 1. The tobacco particle size in this example is preferably 600 μm. The water is used to activate the binder, which together form the thickening stabilizer. Preferably, the binder is carboxymethyl cellulose (CMC), more preferred Ceroga 4550 C. The aerosol releasing substrates of examples 1a and 1b comprise the same visual and tactile properties.

### Example 2

For producing the soft granulated aerosol releasing substrate an exemplary embodiment of the method provides the following procedure:

At first, liquid components of the aerosol releasing substrate, such as water, propylene glycol and glycerin are mixed at ambient conditions, in particular room temperature to create a mixture, preferably for 3 minutes at a mixing speed on level 5. The mixture is thus not heated. In a next step, the gelling agent in the form of gellan gum is added to the mixture, followed by the tobacco particles and the stabilizer in the form of a cellulose derivative. During the whole mixing procedure, the mixture is aerated either mechanically by a mixing machine, or by an injection of air. Preferably, the mixture is mixed in a Kenwood mixer. Preferably, the mixture is mixed for 3 minutes at a mixing speed on level 5 after every addition of an ingredient. Afterwards, the mixture is removed from the mixer and the mixture is further mixed by hand, or in alternative to that in the mixer at a minimum mixing speed, until a homogeneous color of the mixture is achieved.

After the mixture is created, it is aged for at least 4 hours, preferably 24 hours in a closed container at ambient conditions, in particular at room temperature. The mixture is thus neither actively heated, nor actively dried, meaning that the mixture is not affected by technically generated heat during aging. Further, conditions are constant during the whole period of aging. To form the granular structure the mixture is finally sieved down to a granular texture using a 1.7 mm sieve. Preferably, the mixture is sieved through a 1.7 mm sieve for 5 minutes at 280 rpm. This sieving step is repeated until all of the mixture is sieved. The aerosol releasing substrate now preferably comprises a moisture content of 15.94%.

### Example 3

The process is carried out as in Example 2, except that the ingredients are placed in separate barrels and then fed to an extruder, in which the ingredients are compounded at ambient conditions. The final shaping to granules is carried out with a die with multiple holes and a rotating knife cutting the extruded aerosol releasing substrate.

The applicant reserves his right to claim all features disclosed in the application document as being an essential feature of the invention, as long as they are new, individually or in combination, in view of the prior art. Furthermore, it is noted that in the figures features are described, which can be advantageous individually. Someone skilled in the art will directly recognize that a specific feature being disclosed in a figure can be advantageous also without the adoption of further features from this figure. Furthermore, someone skilled in the art will recognize that advantages can evolve from a combination of diverse features being disclosed in one or various figures.

1. An aerosol releasing substrate for use in a heat-not-burn device, the aerosol releasing substrate being air permeable and comprising:
tobacco particles and/or an inhalable agent, which contains at least one of a stimulant and/or a flavor,
a gelling agent for gelling the aerosol releasing substrate, and
a degradation preventing and/or thickening stabilizer,
wherein the aerosol releasing substrate contains 30-70% humectant,
wherein the aerosol releasing substrate has a soft granular texture.

2. The aerosol releasing substrate according to claim 1,
wherein,
the aerosol releasing substrate has particle sizes greater than 0.3 mm and smaller than 10 mm.

3. The aerosol releasing substrate according to claim 1,
wherein,
a weight of the tobacco and/or the inhalable agent is greater than 5 wt. % a weight of the aerosol releasing substrate and smaller than 70 wt. % of the weight of the aerosol releasing substrate.

4. The aerosol releasing substrate according to claim 1,
wherein,
the tobacco particles and/or the inhalable agent contains at least one sort of tobacco, an extract of tobacco and/or at least one non-tobacco flavoring agent, wherein the sort of tobacco has a particle size (Dv90) greater than 100 μm and smaller than 1000 μm.

5. The aerosol releasing substrate according to claim 1,
wherein,
the humectant comprises glycerol, propylene glycol, ethanol and/or water.

6. The aerosol releasing substrate according to claim 1,
wherein,
the humectant comprises propylene glycol and glycerol, and a ratio of the propylene glycol and glycerol is between 80:20 and 20:80.

7. The aerosol releasing substrate according to claim 1,
wherein,
the degradation preventing and/or thickening stabilizer comprises carboxymethylcellulose and/or hydroxyalkylated carbohydrates.

8. The aerosol releasing substrate according to claim 1,
wherein the degradation preventing and/or thickening stabilizer is in an amount greater than 8% and smaller than 30% by weight of the aerosol releasing substrate.

9. The aerosol releasing substrate according to claim 1,
wherein,
the gelling agent is a non-protein containing polysaccharide and/or comprises gellan gum, lecithin, agar and/or mixtures thereof.

10. The aerosol releasing substrate according to claim 1,
where in the gelling agent is in an amount greater than 2% and smaller than 12% by weight of the aerosol releasing substrate.

11. The aerosol releasing substrate according to claim 1,
wherein,
a bulk density of the aerosol releasing substrate is greater than 100 kg/m³ and lower than 500 kg/m³.

12. (canceled)

13. A method of producing a granular aerosol releasing substrate for use in a heat-not-burn device, the aerosol releasing substrate being air permeable, the method comprising the steps:
a) forming a mixture by mixing tobacco particles and/or an inhalable agent, which contains at least one of a stimulant and/or a flavor, a gelling agent for gelling the aerosol releasing substrate, a degradation preventing and/or thickening stabilizer, and 30-70% humectant, and b) forming a granular structure from the mixture.

14. The method according to claim 13,
wherein,
the step of forming the granular structure further comprises sieving the mixture to produce a granular texture of the aerosol releasing substrate.

15. The method according to claim 14,
further comprising feeding the substrate in an extruder between the step of forming the mixture and the step of forming the granular structure, and
wherein the step of forming the granular structure further comprises extruding the substrate through a die with multiple holes and cutting.

16. The method according to claim 13,
wherein,
the mixture is aged.

17. The method according to claim 13,
wherein,
the mixture is aged for 1 to 10 hours and/or at temperatures below 60° C.

18. The method according to one of the claim 13,
wherein,
the step of forming the mixture and the step of forming the granular structure take place at temperatures below 60° C.

19. The method according to claim 14,
wherein,
the mixture is sieved down to particle sizes greater than 0.3 mm and up to particle sizes smaller than 10 mm.

20. The method according to one of the claim 13,
wherein,
a bulk density of the aerosol releasing substrate is greater than 100 kg/m³ and lower than 500 kg/m³.

21. A pod containing the aerosol releasing substrate according to claim 1.
